(19) United States
(12) Patent Application Publication
(10) Pub. No.: US 2006/0285373 A1
(43) Pub. Date: Dec. 21, 2006

(54) Power factor correction circuit

(76) Inventor: Michael Archer, Newbury Park, CA (US)

Correspondence Address: John A. Scillieri;Seldon and Scillieri, 10940 Wilshire Blvd., 18th Floor, Los Angeles, CA, 90024, US

(21) Appl. No.: 10/544,471

(22) PCT Filed: Feb. 4, 2004
(86) PCT No.: PCT/US04/03308

§ 371 Date: Jun. 13, 2006

Related U.S. Application Data
(60) Provisional application No. 60/445,180, filed on Feb. 4, 2003.

(51) Int. Cl. H02M 5/42

(52) U.S. Cl. 363/87

(57) ABSTRACT

A power factor correction circuit which uses incoming AC voltage in a capacitive storage arrangement, forcing a wide conduction angle along with a high frequency boost convertor, to thereby raise the power factor to levels necessary to meet worldwide harmonic current requirements. The boost convertor feeds a resonant convertor from its output, while steering the incoming rectified AC voltage into the capacitive storage arrangement.

### CROSS-REFERENCE TO RELATED APPLICATION

This application claims priority of co-pending U.S. Provisional Application No. 60/445,180, filed Feb. 4, 2003.

### BACKGROUND OF THE INVENTION

Power factor correction, particularly for laptop computers and other portable computers, as well as other circuit arrangements, is typically accomplished by the use of a boost circuit. In this case, a closed convertor uses a main amplifier which is integrated with a large capacitance, thereby allowing the convertor to respond to any changes in the regulated output voltage at a high speed. The PWM stage of the correction circuit is controlled by summing the output of the integrated error amplifier, with a single quadrant multiplier to impose a variable gain on the PWM. This gain is proportional to a sensed haversine waveform derived from the incoming AC line voltage. High frequency current in the power stage will thereupon follow the AC line voltage shape, and this significantly increases the power factor of the input stage. Following this boost correction circuit is a DC to DC convertor that regulates the output voltage after it is stepped up or down through the turns ratio of the DC to DC transformer. The topology used can be any of the conventional approaches, Forward convertor, Half Bridge convertor, fly back convertor, etc. All of these approaches have the ability to adjust the output voltage in response to load changes via their transfer function.

In the fixed frequency resonant convertor, the resonant convertor is not capable of adjusting the output voltage during the DC to DC conversion stage, thus it must rely on the regulation stage in front of it (the power factor correction stage) to accomplish the task of modifying the output voltage in response to load changes. When power factor circuits of prior art are employed, the inability of these circuits to correct for load disturbances at high frequency cause unwanted low frequency noise and poor transient response in the downstream resonant convertor since the resonant convertor has no ability to regulate on its own. Since worldwide regulations now require the power factor to be corrected in most applications, a new approach to power factor is needed to allow the use of fixed frequency resonant convertors to be applied to high density power supply requirements where both the efficiency of the conversion process and the power factor must be maintained. The present invention supplies the solution to this problem.

In fixed frequency resonant convertors, there is a power supply employed, and the output voltage of this power supply is controlled through a boost convertor on the front end thereof, in a manner similar to PFC convertors, normally used to correct power factor. The resonant convertor, however, requires correction to the output of the boost convertor at high frequency. This will facilitate correction of the output voltage to correspond to changes in downstream loads. Moreover, this essentially makes the boost convertor unable to correct any power factor, and thus requires the input stage to be capacitive.

The prior art generally relies upon the use of a full wave rectifier (four diodes connected in a ring), for DC to DC conversion. However, there is a limit on the current, such as, for example, 8.5 milliamps in the United States. Moreover, it is desirable to avoid loading up a transformer if there is only a 10 watt demand. Consequently, power factor must be increased. The convertor operates in conjunction with a capacitor, and the convertor operates at all times to charge the capacitor, so that when the current is zero, the capacitance is zero.

Worldwide power regulation requires input harmonics to be maintained at a specific percentage to improve power distribution quality. As a result, a new approach is needed to solve the problem without adding undue cost to the power supply. The present invention-provides the solution td this problem.

### OBJECTS OF THE INVENTION

A novel power factor correction circuit which utilizes energy from a conventional boost circuit operating at a high gain bandwidth to correct line harmonics, without requiring a closed loop performance of the upstream boost to be compromised. Other objects will be apparent to those having ordinary skill in the art.

### SUMMARY OF THE INVENTION

The present invention provides a power factor correction circuit which utilizes a conventional boost circuit, as previously described. Using this new arrangement, the power factor correction dilemma is solved by steering the incoming rectified voltage to a capacitive storage arrangement. This capacitive storage arrangement forces the conduction angle of the AC voltage to be inherently wide. Energy from the high frequency boost convertor is then pumped into the rectifier network, to improve fill in current in the network. This raises the power factor levels by a sufficient amount to comply with worldwide harmonic current requirements.

Since the boost convertor does not sense the presence of the power factor network, the gain bandwidth product of the boost convertor can be maintained at the desirable high levels, which will insure accuracy in output regulation and noise, and nevertheless, still meet the harmonic current requirements on the input side. In effect, the circuit arrangement as proposed effectively eliminates the need for a multiplier. However, this normally would affect the accomplishment of power factor correction. The circuit of the invention overcomes this dilemma by using a capacitive storage of energy, and that energy is injected into the circuit.

This present invention thereby provides a unique and novel power factor correction circuit, which thereby fulfills the above-identified object and other objects which will become more fully apparent from the consideration of the forms in which it may be embodied. One of these forms is more fully illustrated in the accompanying drawings and described in the following detailed description of the invention. However, it should be understood that the accompanying drawings and this detailed description are set forth only for purposes of illustrating the general principles of the invention.

### BRIEF DESCRIPTION OF THE DRAWINGS

Having thus described the invention in general terms, reference will be made to the accompanying drawings in which:

FIG. 1 is a schematic circuit diagram showing a conventional boost power factor correction circuit;

FIG. 2 is a diagrammatic view of waveforms, achieved with the power factor correction circuit of FIG. 1;

FIG. 3 is a schematic circuit diagram of a power factor correction circuit, in accordance with the present invention; and

FIG. 4 is a diagrammatic view of waveforms, achieved in accordance with the power factor correction circuit of FIG. 3.

### DETAILED DESCRIPTION OF PREFERRED EMBODIMENT

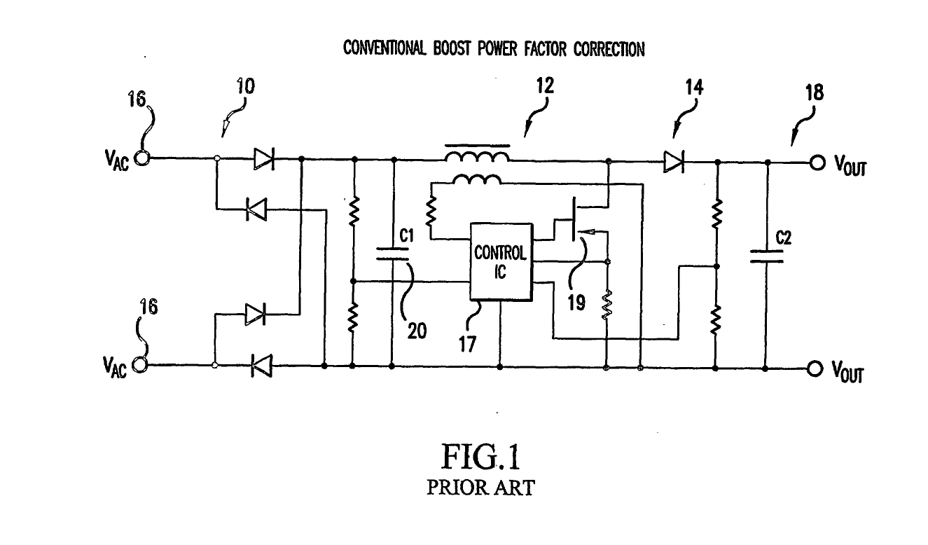

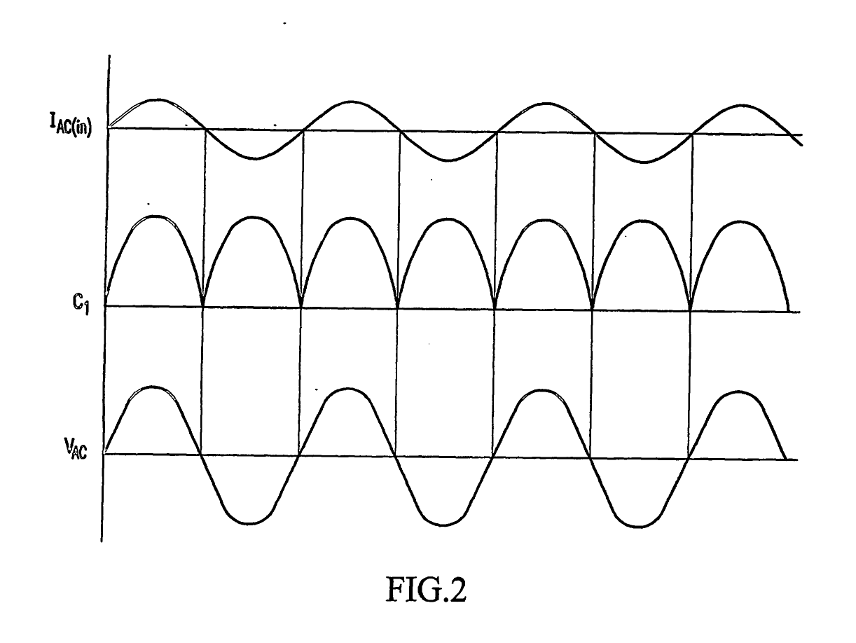

The power factor correction circuit of FIG. 1 is arranged to correct the power factor in a normal power supply arrangement. This power supply of FIG. 1 typically includes a rectifier circuit 10, along with a high frequency boost convertor circuit 12, including a high frequency switch 19, a control IC 17 integrated with a large capacitor C2. The amplifier 14 is preferably an integrated error amplifier, along with a multiplier to provide a variable gain function, proportional to a sensed haversine waveform, derived from the incoming line voltage across the terminals 16. By reference to FIG. 2, it can be seen that the incoming voltage V_{AC} is filtered by a capacitive stage 20. A sample voltage is fed into a single quadrant multiplier to apply a variable gain function, proportional to the incoming AC line voltage. In this way, the high frequency current in the power stage will follow the AC line voltage shape, essentially as shown in the waveform C1 in FIG. 2. The current is shown in the waveform I_{AC} in FIG. 2.

However, the arrangement as shown in FIG. 1 with the voltage and current waveforms, as shown in FIG. 2, does not provide for correction to the output boost at high frequency. The boost convertor is essentially unable to correct for any load changes and can only correct power factor.

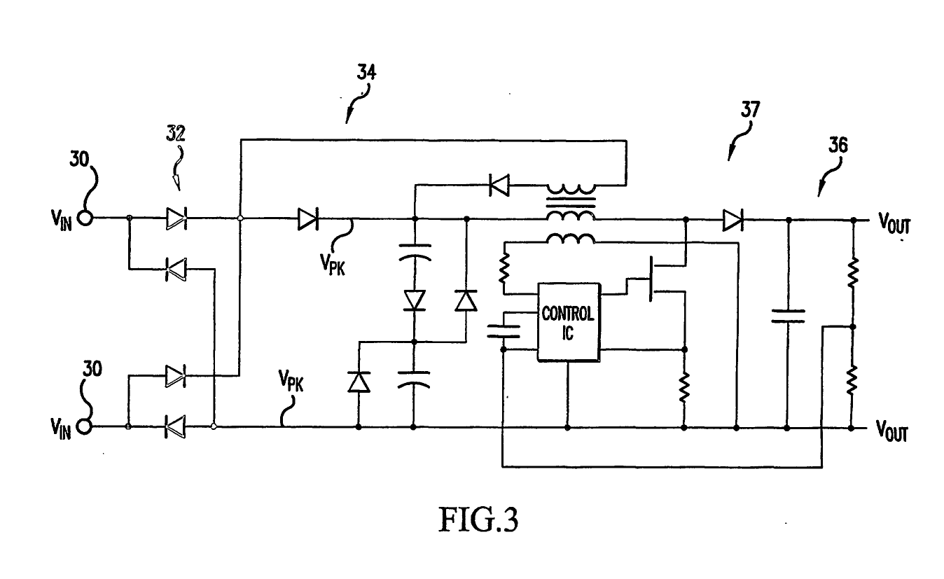

In accordance with the present invention, a circuit of the type as shown in FIG. 3, is provided. In accordance with the circuit of FIG. 3, AC voltage is applied at terminals 30, along with a rectifier 32 to rectify the AC voltage. There is also a boost convertor stage 34, and a capacitive storage arrangement 36, for storing energy from the high frequency boost convertor.

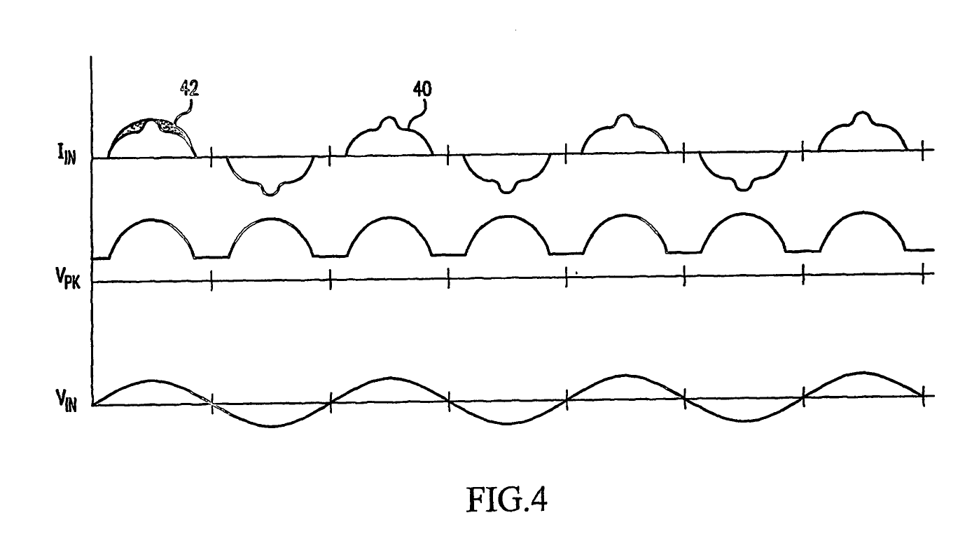

By reference to FIG. 4, the voltage input is shown by the waveform V_{IN} in FIG. 4. The corrected power factor voltage is shown by the waveform V_{PK} in FIG. 4. However, the conduction angle is forced to be inherently wide and the circuit pumps energy from the high frequency boost convertor circuit 34, into a steering circuit 37. This energy which is held in the capacitive circuit 36 fills in the current in the waveform I_{IN}, as shown. Thus, it can be observed that the waveform initially adopts a shape 40, as shown in FIG. 4. However, the waveform is filled in with the areas 42 as shown in I_{IN} of FIG. 4. In other words, the convertor will fill in the current in the network by raising the power factor to levels necessary to meet the harmonic current requirements.

The boost convertor does not actually sense the power factor network, as aforesaid. Thus, the gain bandwidth of the boost convertor can be maintained at high levels, to insure accuracy in the output, regulation and noise, and still meet harmonic current requirements at the input terminals 30.

Thus, there has been illustrated and described a unique and novel power factor correction circuit, and which thereby fulfills all of the objects and advantages which have been sought. It should be understood that many changes, modifications, variations, and other uses and applications will become apparent to those having ordinary skill in the art after considering this specification and the accompanying drawings. Therefore, any and all such changes, modifications, variations and other uses and applications which do not depart from the spirit and scope of the invention are deemed to be covered by the invention.

Having thus described the invention, what I claim is:

1. A power factor correction circuit capable of correcting line harmonics without requiring a closed loop performance, said power factor correction circuit comprising:
a) a rectifier stage for receiving an incoming AC voltage and rectifying same to a DC voltage;
b) a high frequency boost convertor arranged to fill in current in a current signal raising the power factor to levels to meet harmonic current requirements at the input;
c) a steering circuit for steering incoming rectified AC voltage; and,
d) a capacitive storage arrangement located to receive the steered incoming rectified AC voltage for forcing a conduction angle to be wide and for allowing energy from the boost convertor to fill in any gaps in the waveform thus produced.
